(19) United States
(12) Patent Application Publication
(10) Pub. No.: US 2012/0285204 A1
(43) Pub. Date: Nov. 15, 2012

(54) KNITTING AND CROCHETING AID APPARATUS

(76) Inventor: Sharon Jean Coleman, Chepachet, RI (US)

(21) Appl. No.: 13/463,798

(22) Filed: May 3, 2012

Related U.S. Application Data
(60) Provisional application No. 61/485,493, filed on May 12, 2011.

(51) Int. Cl. D04B 3/00; B23P 11/00

(52) U.S. Cl. 66/1 A; 29/428

(57) ABSTRACT

The present invention relates generally to knitting and crocheting. More particularly, the present invention relates to an apparatus for simplified and controlled counting of rows during knitting and crocheting.

### CROSS-REFERENCE TO RELATED APPLICATIONS

This application claims the benefit of the following provisional applications, each of which is hereby incorporated by reference in its entirety: U.S. Pat. App. No. 61/485,493 filed on May 12, 2011 and entitled “KNITTING AND CROCHETING AID APPARATUS.”

### FIELD OF THE INVENTION

The present invention relates generally to knitting and crocheting. More particularly, the present invention relates to an apparatus for simplified and controlled counting of rows during knitting and crocheting.

### BACKGROUND

There are several row counting devices on the market. These include devices that must be placed on a table or other surface while a knitter or crocheter works. Other row counting devices on the market are easily misplaced and/or have small number displays. Still other row counting devices include bracelets which are awkward to use, requiring the manipulation of a bead through an elastic loop after each row. There are also manual clicking counters that can be attached to a string around the neck, but are unsightly and inconvenient to use.

Finally, other row counting devices include small bead-like counters with a dial to turn after each row or with small number displays which must be affixed to the needle and consequently interfere with the work. Additionally, these devices don't work for crochet at all. All of the aforementioned devices either slow the pace of the person working, are not worn or both.

Therefore, there is a need in the art for an apparatus for efficiently and effectively counting rows during knitting and/or crocheting without pause. These and other features and advantages of the present invention will be explained and will become obvious to one skilled in the art through the summary of the invention that follows.

### SUMMARY OF THE INVENTION

Accordingly, an apparatus for efficiently and effectively counting rows during knitting and/or crocheting without pause is provided.

According to an embodiment of the present invention, a knitting and crocheting aid apparatus includes: a toggle clasp pair; two ribbon clamps, each ribbon clamp independently connected to one portion of said toggle clasp pair; a ribbon; and a plurality of beads, wherein each bead of said plurality of beads is secured to said ribbon via a double stringing of said ribbon, wherein said knitting and crocheting aid apparatus is configured to allow for the easy and convenient counting of repetitions of a knitting or crocheting process.

According to an embodiment of the present invention, the connection between said each of said ribbon clamps and each of said portion of said toggle clasp pair is accomplished via a plurality of jump rings.

According to an embodiment of the present invention, an adhesive is used to secure said ribbon to said ribbon clamps.

According to an embodiment of the present invention, the ribbon is comprised of a material that allows for a low level of friction or other traction force to be created between each bead of the plurality of beads and the ribbon such that the beads remain in place until moved when desired without impeding a crafter's work.

According to an embodiment of the present invention, the toggle clasp pair comprises a toggle clasp bar and toggle clasp hood.

According to an embodiment of the present invention, A method for creating a knitting and crocheting aid apparatus, includes the steps of: affixing a toggle clasp bar to a first end of a first plurality of links of chain using a jump ring; affixing a second end of said first plurality of links of chain to a first ribbon clamp; affixing a toggle clasp hood to a first end of a second plurality of links of chain using a jump ring; affixing to a second ribbon clamp a second end of said second plurality of links of chain using a jump ring, wherein said second plurality of links of chain contains the same number of chain links as in the first plurality of links of chain; cutting a ribbon into four equal lengths; gluing each of a first end of the four equal lengths of ribbon to an inside portion of said first ribbon clamp; stringing a first plurality of beads on a first two lengths of said four equal lengths of ribbon with the first two lengths crossing inside each bead of said first plurality of beads; stringing a second plurality of beads on a second two lengths of said four equal lengths of ribbon with the second two lengths crossing inside each bead of said second plurality of beads; and gluing a second end the four equal lengths of ribbon to an inside portion of said second ribbon clamp.

According to an embodiment of the present invention, an adhesive is used in said gluing steps.

Other features and advantages of the present device will be apparent from the accompanying drawings, and from the detailed description, which follows below.

### BRIEF DESCRIPTION OF THE DRAWINGS

Referring to the drawings, wherein like reference numerals are used to designate like parts:

FIG. 1 shows a perspective view of an exemplary knitting and crocheting aid apparatus in accordance with an embodiment of the present invention.

FIG. 2 shows a front view of an exemplary knitting and crocheting aid apparatus in accordance with an embodiment of the present invention.

FIG. 3 shows a top view of an exemplary knitting and crocheting aid apparatus in accordance with an embodiment of the present invention.

FIG. 4 shows a bottom view an exemplary knitting and crocheting aid apparatus in accordance with an embodiment of the present invention.

FIG. 5 shows a side view of an exemplary knitting and crocheting aid apparatus in accordance with an embodiment of the present invention.

FIG. 6 shows a front view of an exemplary knitting and crocheting aid apparatus in accordance with an embodiment of the present invention.

### DETAILED SPECIFICATION

The present invention relates generally to knitting and crocheting. More particularly, the present invention relates to an apparatus for simplified and controlled counting of rows during knitting and crocheting.

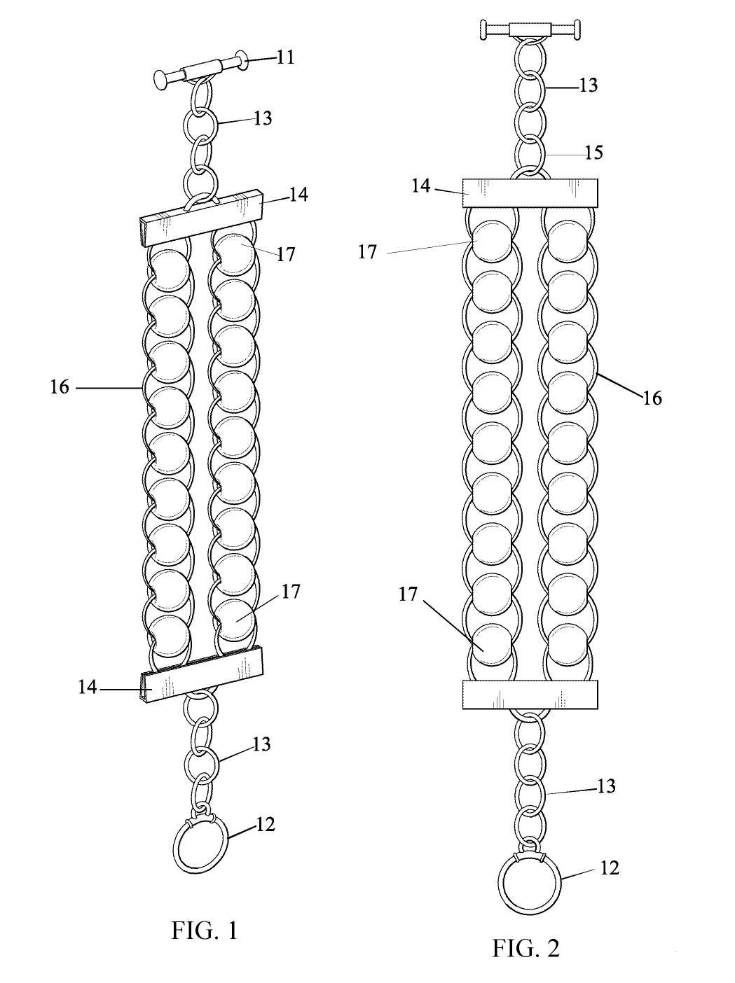

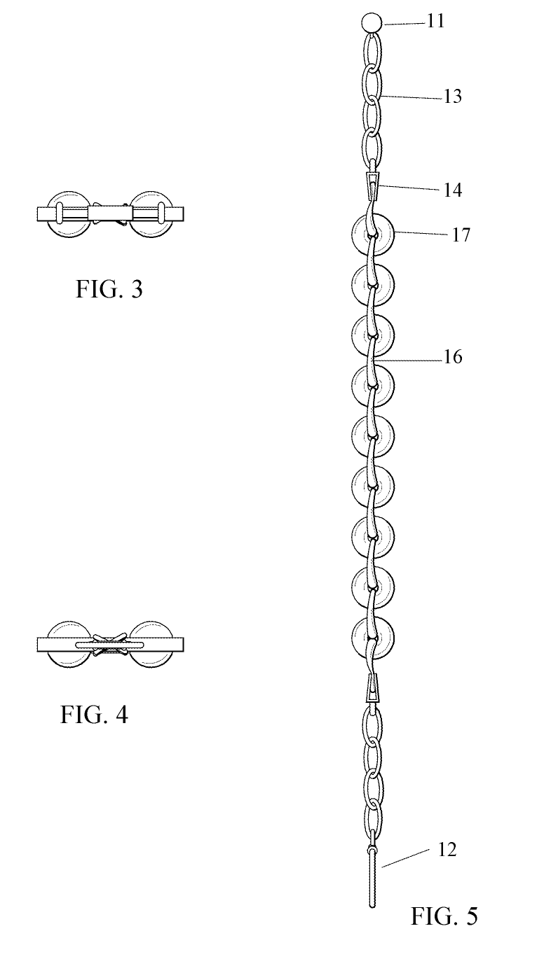

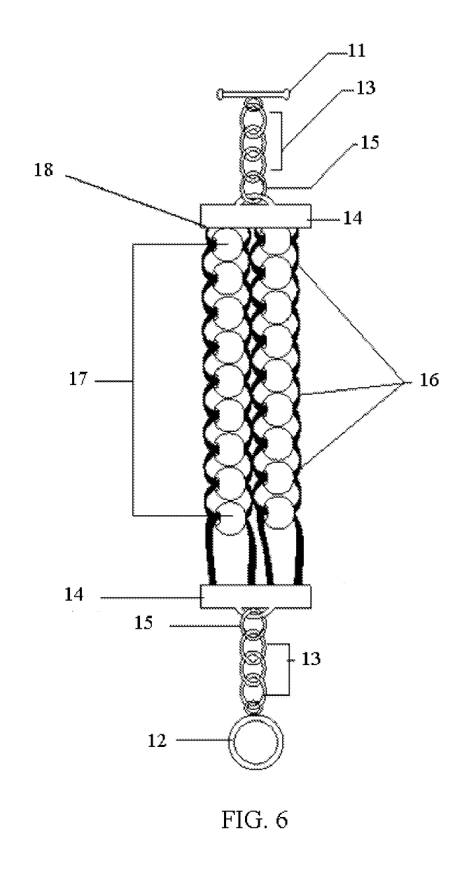

Turning now to FIGS. 1-6, an exemplary knitting and crocheting aid apparatus, in accordance with an embodiment of the present invention, is shown. According to an embodiment of the present invention, the apparatus may be worn on the wrist so it is not easily misplaced. The apparatus does not need to attach to a needle in order to operate.

According to an exemplary embodiment of the present invention, the apparatus is comprised of a toggle clasp pair, two ribbon clamps, between two and four jump rings, ribbon, a plurality of beads (eighteen beads according to an exemplary embodiment of the present invention) and an adhesive.

According to an embodiment of the present invention, the toggle clasp pair may be 13 mm/18 mm and be comprised of a toggle clasp bar 11 and toggle clasp hood end 12. One of ordinary skill in the art would appreciate that any size toggle clasp may be used with embodiments of the present invention, and embodiments of the present invention are contemplated for use with any size toggle clasp. Alternately any style of jewelry clasp may also be used including, but not limited to magnetic clasps, hook clasps, lobster claw clasps and barrel clasps.

Optionally, embodiments of the present invention may be further comprised of a plurality of links of chain 13 (preferably 8 mm×6 mm, but other sizes and lengths may be used). The links of chain are used to adjust the size and fit of the apparatus. This may be omitted for smaller models or if larger beads are used.

According to an embodiment of the present invention, the Two (2) ribbon clamps 14 may be comprised of 20 mm×6 mm ribbon clamps or of any size big enough to cover the ribbon. One of ordinary skill in the art would appreciate that ribbon clamps of any size may be utilized with embodiments of the present invention, and embodiments of the present invention are contemplated for use with any size ribbon clamps.

According to an embodiment of the present invention, the two (2) to four (4) jump rings 15 are utilized to affix the links of chain to clasps and ribbon clamps.

According to an embodiment of the present invention, the ribbon 16 may be comprised of ⅛ inch wide poly-satin ribbon, preferably 18 inches long. In other embodiments of the present invention, longer or shorter lengths of ribbon may be used. Widths of ¼ inch may work for some beads. Additionally, other stringing materials such as beading threads and filaments, hemp or leather may also be used. One of ordinary skill in the art would appreciate that there are numerous stringing materials that could be used with embodiments of the present invention, and embodiments of the present invention are contemplated for use with any stringing material.

According to an embodiment of the present invention, the ribbon would ideally be comprised of a material that allows for a low level of friction or other traction force to be created between each bead 17 of the plurality of beads and ribbon such that the beads remain in place during knitting or crocheting but are still easily moved when desired without impeding the crafter's work. For this purpose, poly-satin ribbon is an exemplary choice for ribbon in accordance with embodiments of the present invention.

According to an embodiment of the present invention, the plurality of beads may be comprised of eighteen (18) large-hole beads 17, preferably 8mm round. Other bead shapes and sizes may be used. The holes must be wide enough to accommodate double stringing with whichever ribbon or other material is used. One of ordinary skill in the art would appreciate that there are numerous bead shapes and sized that could be used with embodiments of the present invention, and embodiments of the present invention are contemplated for use with beads of any shape or size.

According to an embodiment of the present invention, the adhesive may be comprised of a strong jewelry or craft adhesive. One of ordinary skill in the art would appreciate that there are numerous adhesives that could be used with embodiments of the present invention, and embodiments of the present invention are contemplated for use with any adhesive.

### Exemplary Embodiments

According to an embodiment of the present invention, One end of the clasp is affixed to three (or more) links of chain using one jump ring or directly attached by opening and re-closing one link of chain.

According to an embodiment of the present invention, the same length of chain is also affixed to one ribbon clamp using one jump ring. In alternate embodiments, for smaller models or models with larger beads, the chain may be omitted and the clasp and ribbon clamp may be joined directly with one jump ring.

According to an embodiment of the present invention, the ribbon is cut into four equal lengths. Each of these four lengths is then glued to the inside of the ribbon clamp with a tiny drop of adhesive 18 the ribbon clamp is then clamped shut.

According to an embodiment of the present invention, a first (1) bead of the plurality of beads is strung on the first two strands of ribbon with the strands crossing inside the bead. The two ends of ribbon are then crossed inside a second bead of the plurality of beads, and so on, until nine (9) beads of the plurality of beads have been strung. This process is repeated on the next two lengths of ribbon with the remaining nine (9) beads of the plurality of beads.

According to an embodiment of the present invention, the ends of the ribbon are then glued, using the adhesive 18, inside the remaining ribbon clamp and clamped shut. For the device to work, it is imperative that a space (according to an exemplary embodiment of the present invention, at least the length of one bead or more) be left between the last bead and the ribbon clamp, leaving this length of the ribbon visible.

According to an embodiment of the present invention, the second ribbon clamp is then affixed to another length of chain (equal to the length previously used) with a jump ring. This chain is then attached to the other end of the clasp with another jump ring or directly by opening and closing one link of the chain. Alternatively, for smaller models or models with larger beads the chain may be omitted and the clasp and ribbon clamp may be joined directly with one jump ring.

According to an embodiment of the present invention, the apparatus is quickly and easily used such that a knitter or crocheter does not need to slow his/her pace while working. In operation, one finger is used to slide a bead after each row. Advantageously, one quick glance shows to a knitter or crocheter what row he/she is on.

The apparatus works by sliding one bead in the first row (the ones column) into the gap of the strings. Each count another bead is moved until the 9th bead has been moved into the space. These nine beads are then moved back to their original position and the first bead on the next row is moved (the 10s column).

According to an embodiment of the present invention, the apparatus herein described may be used in any situation where counting combined with aesthetic appeal are warranted. Situations include, but are not limited to counting exercise repetitions, calories, or to keeping track in card games. One of ordinary skill in the art would appreciate that there are numerous situations where counting on an apparatus in accordance with embodiments of the present invention would be desirable, and embodiments of the present invention are contemplated for use with any counting situation.

In another embodiment of the present invention, the toggle clasps could be comprised of two “female” ends, one on either side of the section comprising the plurality of beads. In this manner, there may be an section with two “male” ends so that the apparatus may dangle from the needle or be worn conveniently on the crafter.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A knitting and crocheting aid apparatus, said apparatus comprising:
a toggle clasp pair;
two ribbon clamps, each ribbon clamp independently connected to one portion of said toggle clasp pair;
a ribbon; and
a plurality of beads, wherein each bead of said plurality of beads is secured to said ribbon via a double stringing of said ribbon,
wherein said knitting and crocheting aid apparatus is configured to allow for the easy and convenient counting of repetitions of a knitting or crocheting process.

2. The knitting and crocheting aid apparatus of claim 1, wherein said connection between said each of said ribbon clamps and each of said portion of said toggle clasp pair is accomplished via a plurality of jump rings.

3. The knitting and crocheting aid apparatus of claim 1, wherein an adhesive is used to secure said ribbon to said ribbon clamps.

4. The knitting and crocheting aid apparatus of claim 1, wherein said ribbon is comprised of a material that allows for a low level of friction or other traction force to be created between each bead of the plurality of beads and the ribbon such that the beads remain in place until moved when desired without impeding a crafter's work.

5. The knitting and crocheting aid apparatus of claim 1, wherein said toggle clasp pair comprises a toggle clasp bar and toggle clasp hood.

6. A method for creating a knitting and crocheting aid apparatus, said method comprising the steps of:
affixing a toggle clasp bar to a first end of a first plurality of links of chain using a jump ring;
affixing a second end of said first plurality of links of chain to a first ribbon clamp;
affixing a toggle clasp hood to a first end of a second plurality of links of chain using a jump ring;
affixing to a second ribbon clamp a second end of said second plurality of links of chain using a jump ring, wherein said second plurality of links of chain contains the same number of chain links as in the first plurality of links of chain;
cutting a ribbon into four equal lengths;
gluing each of a first end of the four equal lengths of ribbon to an inside portion of said first ribbon clamp;
stringing a first plurality of beads on a first two lengths of said four equal lengths of ribbon with the first two lengths crossing inside each bead of said first plurality of beads;
stringing a second plurality of beads on a second two lengths of said four equal lengths of ribbon with the second two lengths crossing inside each bead of said second plurality of beads; and
gluing a second end the four equal lengths of ribbon to an inside portion of said second ribbon clamp.

7. The method for creating a knitting and crocheting aid apparatus of claim 6, wherein an adhesive is used in said gluing steps.

8. The method for creating a knitting and crocheting aid apparatus of claim 6, wherein said ribbon is comprised of a material that allows for a low level of friction or other traction force to be created between each bead of the first and second plurality of beads and the equal lengths of ribbon such that the beads remain in place until moved when desired without impeding a crafter's work.
